(19) United States
(12) Patent Application Publication
(10) Pub. No.: US 2026/0051792 A1
(43) Pub. Date: Feb. 19, 2026

(54) ELECTRIC MOTOR WITH AIRGAP AND MAGNET SLOT COOLING

(71) Applicant: GM GLOBAL TECHNOLOGY OPERATIONS LLC, Detroit, MI (US)

(72) Inventors: Xiaofeng Yang, Troy, MI (US); Dongxu Li, Troy, MI (US); Derek F. Lahr, Ann Arbor, MI (US); Rebecca K. Risko Cattell, Royal Oak, MI (US); Edward L. Kaiser, Orion, MI (US)

(73) Assignee: GM GLOBAL TECHNOLOGY OPERATIONS LLC, Detroit, MI (US)

(21) Appl. No.: 18/804,682

(22) Filed: Aug. 14, 2024

(51) Int. Cl. H02K 9/19; H02K 1/276; H02K 1/32; H02K 21/14

(52) U.S. Cl. CPC H02K 9/19; H02K 1/276; H02K 1/32; H02K 21/14

(57) ABSTRACT

An electric motor includes a stator having a radially inner stator core surface and a rotor. The rotor has opposite rotor ends, a radially outer surface positioned proximate the radially inner stator core surface to define an airgap, and a radially inner surface spaced apart from the outer surface to define a plurality of magnet slots. The rotor includes a fluid circulation arrangement having at least one fluid channel extending within the rotor to the outer surface and configured to receive a liquid and a gas, direct at least one of the liquid and gas, via centrifugal force, into the plurality of magnet slots, direct at least another one of the liquid and gas, via centrifugal force, into the airgap, and discharge the liquid and gas out of the magnet slots and airgap at the rotor ends as the rotor rotates inside the stator to thereby cool the electric motor.

### The disclosure relates to an electric motor and a vehicle.

An electric motor converts electric energy into mechanical energy based on electromagnetic interaction between permanent magnets and a magnetic field created by selectively energized coils to thereby generate torque and thermal energy. Cooling of the electric motor may reduce thermal stress on, for example, a rotor, stator, motor poles, windings and/or end-turns of the electric motor under or close to peak load. Additionally, cooling may facilitate reduced motor packaging.

### SUMMARY

An electric motor includes a stator having a radially inner stator core surface and a rotor mounted inside the stator and rotatable about a rotational axis. The rotor has axially opposite rotor ends, a radially outer rotor surface extending between the axially opposite rotor ends and positioned proximate the radially inner stator core surface to define an airgap therebetween, and a radially inner rotor surface spaced apart from the radially outer rotor surface to define a plurality of magnet slots therebetween each configured to house a respective one of a plurality of magnets therein. The rotor includes a fluid circulation arrangement having at least one fluid channel extending within the rotor to the radially outer rotor surface and configured to receive a liquid and a gas, direct at least one of the liquid and the gas, via centrifugal force, into the plurality of magnet slots, direct at least another one of the liquid and the gas, via centrifugal force, into the airgap, and discharge the liquid and the gas out of the plurality of magnet slots and the airgap at the axially opposite rotor ends as the rotor rotates inside the stator to thereby cool the electric motor.

In one aspect, the electric motor may further include a shaft disposed along the rotational axis. The rotor may have a radially internal rotor core surface disposed in contact with the shaft and spaced apart from the radially outer rotor surface. The at least one fluid channel may extend through the rotor from the radially internal rotor core surface to the radially outer rotor surface.

In an additional aspect, the electric motor may further include an impeller disposed within the at least one fluid channel and rotatable about the rotational axis. The impeller may be configured to separate the liquid and the gas, pump the gas into the airgap to thereby directly cool the rotor, and inject the liquid into the plurality of magnet slots to thereby directly cool the plurality of magnets.

In another aspect, the impeller may include a blade sandwiched between a first cover and a second cover.

In a further aspect, the rotor may be formed from a plurality of laminations stacked against one another. The impeller may be sandwiched between two adjacent ones of the plurality of laminations to thereby define an air path from the radially internal rotor core surface to the airgap and a liquid path from the radially internal rotor core surface to the plurality of magnet slots.

In one aspect, the rotor may further include a pair of end rings each configured as an impeller and disposed at a respective one of the axially opposite rotor ends. The at least one fluid channel may extend along each of the end rings, through the plurality of magnet slots, from the radially inner rotor surface to the radially outer rotor surface, and through the airgap. The pair of end rings may pump the liquid and the gas from the axially opposite rotor ends into the plurality of magnet slots to thereby directly cool the plurality of magnets.

In an additional aspect, the rotor may be formed from a plurality of laminations stacked against one another. The plurality of laminations may include a first central lamination and a second central lamination sandwiched against the first central lamination. The first central lamination and the second central lamination may be together configured for directing the liquid and the gas into the airgap.

In another aspect, the at least one fluid channel may be configured to receive the liquid and the gas from the plurality of magnet slots and direct the liquid and the gas, via centrifugal force, into the airgap to discharge the liquid and the gas out of the airgap at the axially opposite rotor ends as the rotor rotates inside the stator to thereby cool the electric motor.

In a further aspect, the impeller may be configured to pump the gas and the liquid into the airgap to thereby directly cool the rotor.

In one aspect, the rotor may further include a pair of end rings each defining a gas inlet and disposed at a respective one of the axially opposite rotor ends.

In an additional aspect, the gas may circulate around each of the pair of end rings, through the gas inlet of each of the pair of end rings, and through the plurality of magnet slots via centrifugal force to thereby directly cool the plurality of magnets.

In another aspect, the impeller may include a plurality of blades and a liquid bridge disposed between two adjacent ones of the plurality of blades. The liquid bridge may be configured to direct liquid from the at least one fluid channel to the airgap to directly cool the rotor and to the plurality of magnet slots to thereby directly cool the plurality of magnets.

In a further aspect, the rotor may further include a pair of end rings each disposed at a respective one of the axially opposite rotor ends. Each of the pair of end rings may further define a liquid outlet configured for directing the liquid out of the plurality of magnet slots.

In one aspect, the rotor may be formed from a plurality of laminations stacked against one another. The plurality of laminations may include two bridge laminations disposed adjacent and in contact with the impeller and each configured for minimizing injection of the liquid from the at least one fluid channel into the airgap.

In an additional aspect, the rotor may further include an end ring configured as an impeller and disposed at a respective one of the axially opposite rotor ends.

In a further aspect, the rotor may further include a shaft and the rotor may have a radially internal rotor core surface disposed in contact with the shaft and spaced apart from the radially outer rotor surface. The rotor may also include a plurality of laminations stacked adjacent one another to define the at least one fluid channel extending from the shaft to the radially internal rotor core surface.

In one aspect, the end ring may pump the gas to the plurality of magnet slots and to the airgap, and the plurality of laminations may direct the liquid to the plurality of magnet slots without directing the liquid to the airgap.

In another embodiment, an electric motor includes a stator having a radially inner stator core surface and a rotor mounted inside the stator and rotatable about a rotational axis.

The rotor has axially opposite rotor ends, a radially outer rotor surface extending between the axially opposite rotor ends and positioned proximate the radially inner stator core surface to define an airgap therebetween, and a radially inner rotor surface spaced apart from the radially outer rotor surface to define a plurality of magnet slots therebetween each configured to house a respective one of a plurality of magnets therein. The rotor may be formed from a plurality of laminations stacked against one another. The rotor may include a fluid circulation arrangement having at least one fluid channel extending within the rotor to the radially outer rotor surface and configured to receive oil and air, direct the oil, via centrifugal force, into the plurality of magnet slots, direct the air, via centrifugal force, into the airgap, and discharge the oil out of the plurality of magnet slots and the air out of the airgap at the axially opposite rotor ends as the rotor rotates inside the stator to thereby cool the electric motor.

A vehicle includes an electric motor configured to generate torque for propulsion of the vehicle. The electric motor includes a stator having a radially inner stator core surface and a rotor mounted inside the stator and rotatable about a rotational axis. The rotor has axially opposite rotor ends, a radially outer rotor surface extending between the axially opposite rotor ends and positioned proximate the radially inner stator core surface to define an airgap therebetween, and a radially inner rotor surface spaced apart from the radially outer rotor surface to define a plurality of magnet slots therebetween each configured to house a respective one of a plurality of magnets therein. The rotor includes a fluid circulation arrangement having at least one fluid channel extending within the rotor to the radially outer rotor surface and configured to receive a liquid and a gas, direct at least one of the liquid and the gas, via centrifugal force, into the plurality of magnet slots, direct at least another one of the liquid and the gas, via centrifugal force, into the airgap, and discharge the liquid and the gas out of the plurality of magnet slots and the airgap at the axially opposite rotor ends as the rotor rotates inside the stator to thereby cool the electric motor.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a vehicle including an electric motor.

FIG. 2 is a schematic illustration of a partial cut-away perspective view of one embodiment of the electric motor of FIG. 1 including a fluid circulation arrangement.

FIG. 3 is a schematic illustration of a cut-away sectional view of the electric motor of FIG. 2 including an impeller configured for directing fluid and gas within the electric motor.

FIG. 4 is a schematic illustration of a cut-away sectional view of the electric motor and an exploded view of the impeller of FIG. 2.

FIG. 5 is a schematic illustration of a cut-away sectional view of the electric motor of FIGS. 2 and 3 as the impeller defines a gas path.

FIG. 6 is a schematic illustration of a cut-away sectional view of the electric motor of FIGS. 2 and 3 as the impeller defines a liquid path.

FIG. 7 is a schematic illustration of a cut-away sectional view of another embodiment of the electric motor of FIG. 1 including a rotor end ring configured as an impeller and a center lamination grouping.

FIG. 8 is a schematic illustration of a cut-away sectional view of the electric motor and end ring of FIG. 7.

FIG. 9 is a schematic illustration of a plan view of an embodiment of the lamination grouping of FIG. 7.

FIG. 10 is a schematic illustration of a plan view of another embodiment of the lamination grouping of FIG. 7.

FIG. 11 is a schematic illustration of a cut-away sectional view of another embodiment of the electric motor of FIG. 1 including an impeller configured for directing fluid and gas within the electric motor.

FIG. 12 is a schematic illustration of an exploded view of a portion of the impeller of FIG. 11.

FIG. 13 is a schematic illustration of a cut-away sectional view of another embodiment of the electric motor of FIG. 1 including an impeller configured for directing fluid and gas within the electric motor.

FIG. 14 is a schematic illustration of a plan view of a portion of the impeller of FIG. 13.

FIG. 15 is a schematic illustration of a cut-away sectional view of another embodiment of the electric motor of FIG. 1 including an impeller configured for directing fluid and gas within the electric motor.

FIG. 16 is a schematic illustration of an exploded view of a portion of the impeller of FIG. 15.

FIG. 17 is a schematic illustration of a cut-away sectional view of another embodiment of the electric motor of FIG. 1 including a plan view of several laminations of the electric motor.

### DETAILED DESCRIPTION

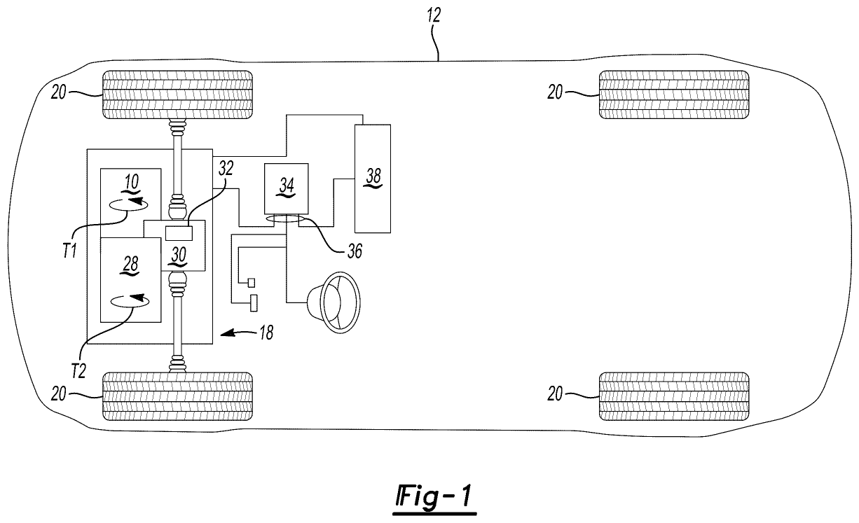

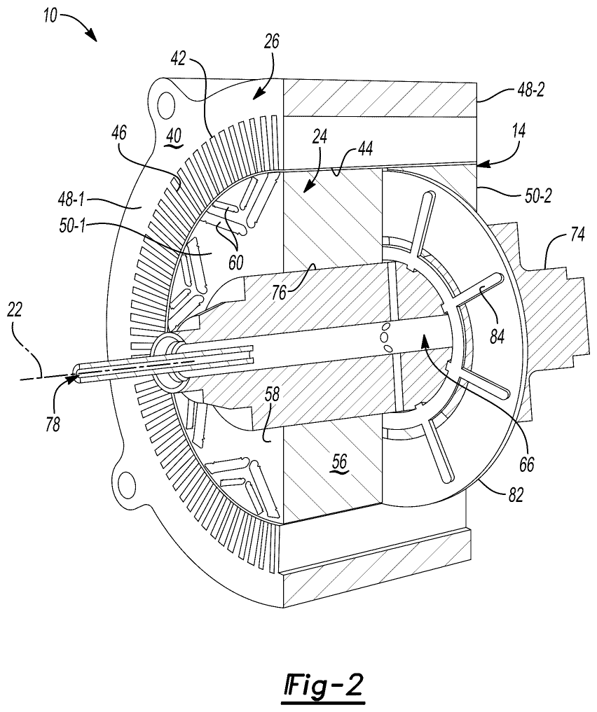

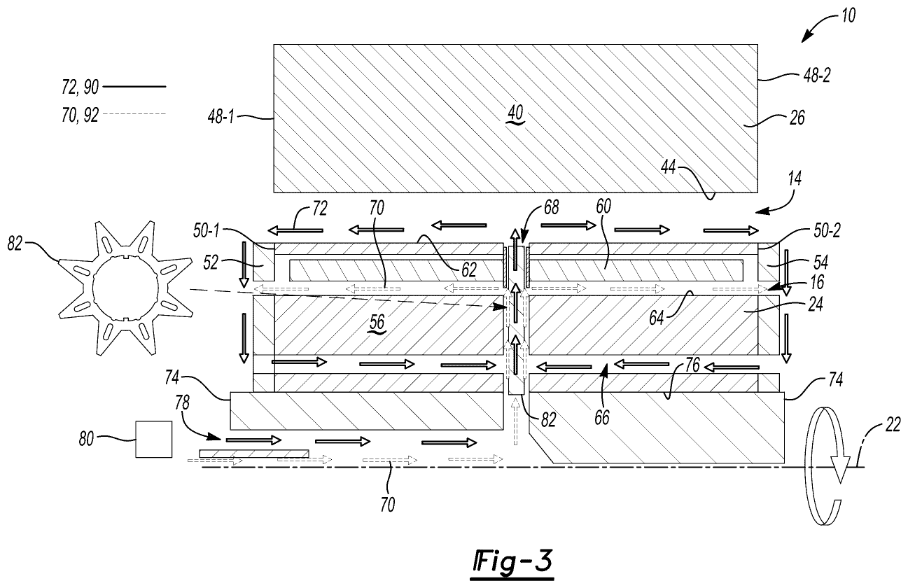

Referring to the Figures, wherein like reference numerals refer to like elements, an electric motor 10 (FIGS. 1 and 2) for a vehicle 12 (FIG. 1) are shown generally. The electric motor 10 and vehicle 12 may be useful for applications requiring excellent performance due to enhanced cooling of the electric motor 10. In particular, the electric motor 10 and vehicle 12 may be useful for cooling both an airgap 14 (FIG. 3) of the electric motor 10 and a plurality of magnet slots 16 (FIG. 3) of the electric motor 10 to enhance operational efficiency of the electric motor 10.

Referring to FIG. 1, the electric motor 10 is configured to generate torque T1 for propulsion of the vehicle 12. Therefore, the electric motor 10 and vehicle 12 may be useful for automotive applications such as, but not limited to, electric vehicles, hybrid vehicles, and the like. For example, the vehicle 12, such as a motor vehicle powered by at least one of an internal combustion engine 28, the electric motor 10, and an energy storage system or device 38, may include the electric motor 10. Alternatively, the electric motor 10 and vehicle 12 may be useful for non-automotive applications such as, but not limited to, aerospace, aviation, marine, mass transportation, agricultural, industrial, and rail applications.

Referring again to FIG. 1, the vehicle 12 having a powertrain 18 is depicted. The vehicle 12 may include, but not be limited to, a commercial vehicle, industrial vehicle, passenger vehicle, aircraft, watercraft, train or the like. It is also contemplated that the vehicle 12 may be a mobile platform, such as an airplane, all-terrain vehicle (ATV), boat, personal movement apparatus, robot, and the like to accomplish the purposes of this disclosure. The powertrain 18 may include a first power-source depicted as an electric motor-generator 10 and configured to generate a first power-source torque T1 for propulsion of the vehicle 12 via driven wheels 20 relative to a road surface. The electric motor 10 may be configured as a radial flux electric motor, where the magnetic flux is generated perpendicular to a rotational axis 22 (FIG. 2) of the electric motor 10 and the airgap 14 between a rotor 24 and stator 26 of the electric motor 10 is arranged concentrically with the rotational axis 22.

As shown in FIG. 1, the powertrain 18 may also include a second power-source 28, such as an internal combustion engine configured to generate a second power-source torque T2. The power-sources 10 and 28 may act in concert to power the vehicle 12 and may be operatively connected to a transmission assembly 30. The transmission assembly 30 may be configured to transmit the first and/or second power-source torques T1, T2 to a final drive unit 32, which in turn may be connected to the driven wheels 20. The first power-source 10, which for the remainder of the present disclosure will be referred to as the electric motor 10 or motor-generator, may, for example, be mounted to the second power-source 28, mounted to (or incorporated into) the transmission assembly 30, mounted to the final drive unit 32, or be a stand-alone assembly mounted to the structure of the vehicle 12. As shown, the vehicle 12 may additionally include a programmable electronic controller 34 configured to communicate via a high-voltage BUS 36 and control the powertrain 18 to generate a predetermined amount of power-source torque (sum of T1 and T2), and various other vehicle systems. The vehicle 12 may additionally include an energy storage system or device 38, such as one or more batteries, configured to generate and store electrical energy for powering the power-sources 10 and 28.

FIG. 2 illustrates a general cross-section of the electric motor 10. The electric motor 10 includes a rotationally fixed stator 26 having a generally cylindrical stator core 40 and winding slots 42. The stator 26 has a radially inner stator core surface 44. The electric motor 10 also includes a rotor 24 mounted inside the stator 26 and rotatable about the rotational axis 22. The stator 26 may include multiphase AC windings 46 arranged within the winding slots 42, wherein the windings receive multiphase AC from a power inverter to establish a rotating magnetic field exerting torque T1 upon the rotor 24 The stator windings 46 may be generally contained within the winding slots 42 with end turns of the windings 46 extending beyond the limits of the cylindrical core 40 at axially opposite stator ends—a first end 48-1 and a second end 48-2.

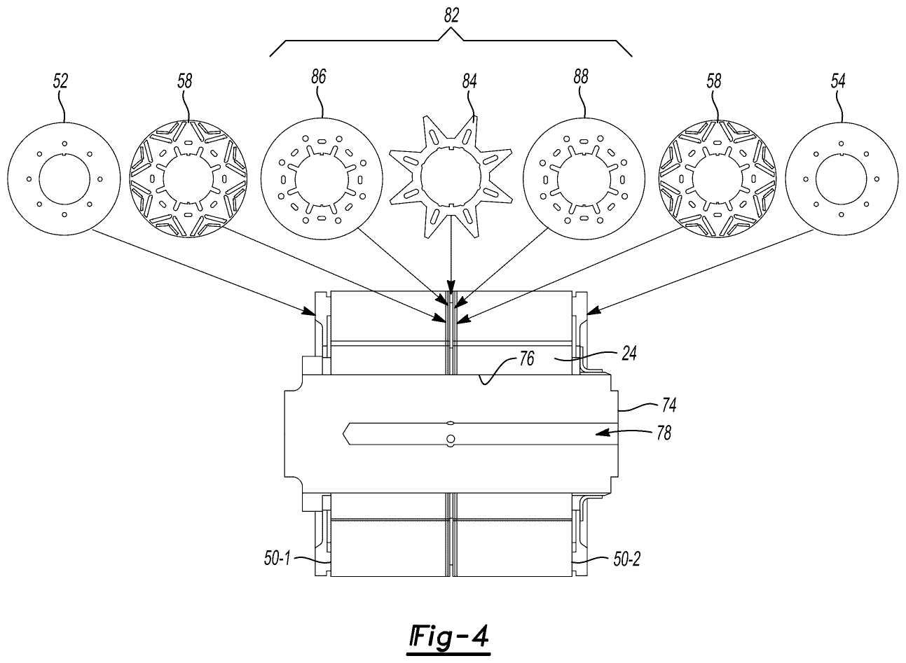

Referring again to FIG. 2, the rotor 24 has axially opposite rotor ends—a first end 50-1 and a second end 50-2 and may include a pair of end rings 52, 54 each disposed at a respective one of the axially opposite rotor ends 50-1, 50-2. Further, the rotor 24 may have a ferromagnetic rotor core 56. The rotor core 56 may be constructed from a relatively soft magnetic material, such as a plurality of laminations 58 (FIG. 4) stacked against one another and formed from laminated silicon steel. In a permanent magnet machine, the stacked rotor laminations 58 may include voids forming interior pockets for carrying permanent magnets 60, as set forth in more detail below. In an induction machine, the stacked laminations 58 may include peripheral slots for carrying conduction bars (not shown). Alternative constructions of the rotor 24 may also be used and may include, for example, surface mounted permanent magnet and wire wound rotors 24.

Referring now to FIGS. 2 and 3, the rotor 24 has a radially outer rotor surface 62 extending between the axially opposite rotor ends 50-1, 50-2 and positioned proximate the radially inner stator core surface 44 to define the airgap 14 therebetween. That is, the airgap 14 may extend between the axially opposite first end 50-1 and second end 50-2 of the rotor 24. The rotor 24 also includes a radially inner rotor surface 64 spaced apart from the radially outer rotor surface 62 to define the plurality of magnet slots 16 therebetween. Each of the plurality of magnet slots 16 is configured to house a respective one of the plurality of magnets 60 therein.

As shown in FIGS. 2 and 3, the rotor 24 also includes a fluid circulation arrangement 66 having at least one fluid channel 68 extending radially within the rotor 24 to the radially outer rotor surface 62. The fluid circulation arrangement 66 is configured to receive a liquid 70 and a gas 72. Specifically, the liquid 70 may be a pressurized oil and the gas 72 may be air and the liquid 70 and gas 72 may be used for cooling the electric motor 10. More specifically, the fluid circulation arrangement 66 is further configured to direct at least one of the liquid and the gas 70, 72, via centrifugal force, into the plurality of magnet slots 16, direct at least another one of the liquid 70 and the gas 72, via centrifugal force, into the airgap 14, and discharge the liquid 70 and the gas 72 out of the plurality of magnet slots 16 and the airgap 14 at the axially opposite rotor ends 50-1, 50-2 as the rotor 24 rotates inside the stator 26 to thereby cool the electric motor 10. That is, as set forth in more detail below, the fluid circulation arrangement 66 is thereby configured to cool the electric motor 10 by circulating one or more of the liquid 70 and the gas 72 within the airgap 14 and the plurality of magnet slots 16 of the rotor 24.

Referring now to FIG. 3, the electric motor 10 may further include a shaft 74 disposed along the rotational axis 22, and the rotor 24 may rotate about the shaft 74 within the stationary stator 26. More specifically, the rotor 24 may have a radially internal rotor core surface 76 disposed in contact with the shaft 74 and spaced apart from the radially outer rotor surface 62. In addition, the shaft 74 may define a passageway 78 fluidly connected to one or more sumps 80 or inlets for at least one of the liquid 70 and the gas 72. For the embodiment described with reference to FIG. 3, the at least one fluid channel 68 may extend through the rotor 24 from the radially internal rotor core surface 76 to the radially outer rotor surface 62. That is, the at least one fluid channel 68 may extend entirely through the rotor core 56.

As described with continued reference to FIG. 3, the rotor 24 may further include an impeller 82 disposed within the at least one fluid channel 68 and rotatable about the rotational axis 22. The impeller 82 may be a liquid-gas separation impeller configured for separating the liquid 70 and the gas 72 into one or more streams within the rotor 24 via centrifugal force as the impeller 82 rotates about the rotational axis 22 during operation of the electric motor 10.

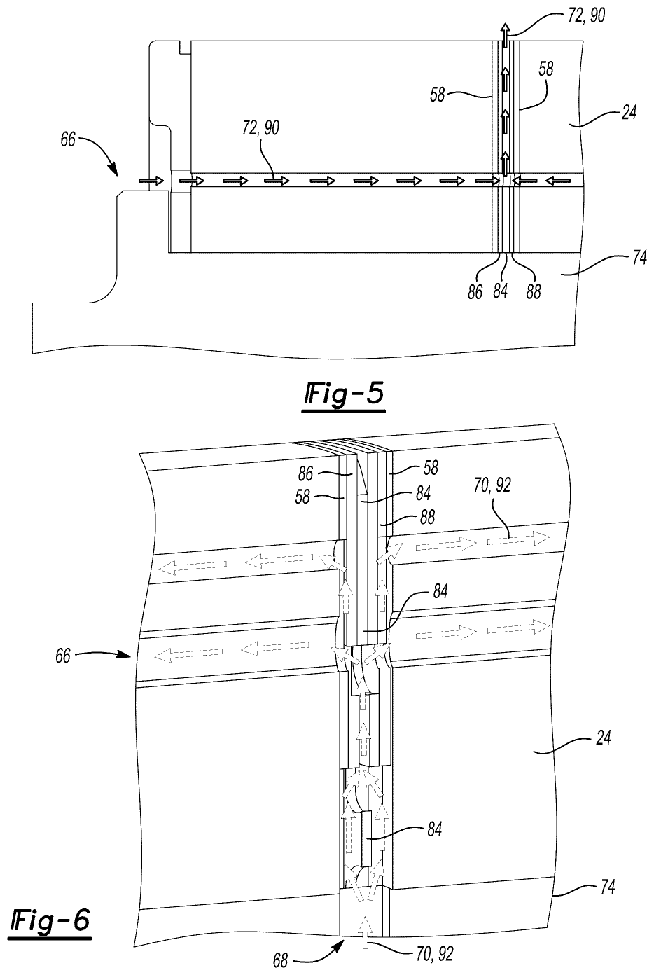

Referring to FIG. 4, in one non-limiting example, the impeller 82 may include a blade 84 sandwiched between a first cover 86 or guide and a second cover 88 or guide. That is, the impeller 82 may have a three-part structure. Further, as best shown in FIGS. 5 and 6, the impeller 82 may be sandwiched between two adjacent ones of the plurality of laminations 58 to thereby define an air path 90 (FIG. 5) from the radially internal rotor core surface 76 to the airgap 14 and a liquid path 92 (FIG. 6) from the radially internal rotor core surface 76 to the plurality of magnet slots 16. As such, referring again to FIG. 3, the impeller 82 may be configured to separate the liquid 70 and the gas 72, pump the gas 72 into the airgap 14 to thereby directly cool the rotor 24, and inject the liquid 70 into the plurality of magnet slots 16 to thereby directly cool the plurality of magnets 60.

More specifically, as described with continued reference to FIG. 3, the liquid 70 and gas 72 may enter the rotor 24 from the sump 80 or inlet, flow through the passageway 78 of the shaft 74 to the at least one fluid channel 68, and encounter the impeller 82. The impeller 82 may separate the liquid 70 and the gas 72 such that the gas 72 or air travels along the air path 90 (FIGS. 4 and 5) to the airgap 14, around the end rings 52, 54 of the rotor 24, and back to the at least one fluid channel 68. The liquid 70 may travel through the plurality of magnet slots 16 and out of the end rings 52, 54. As such, the rotor 24 may be cooled by the gas 72 via airgap cooling and the plurality of magnets 60 may be cooled by the liquid 70 via magnet slot cooling.

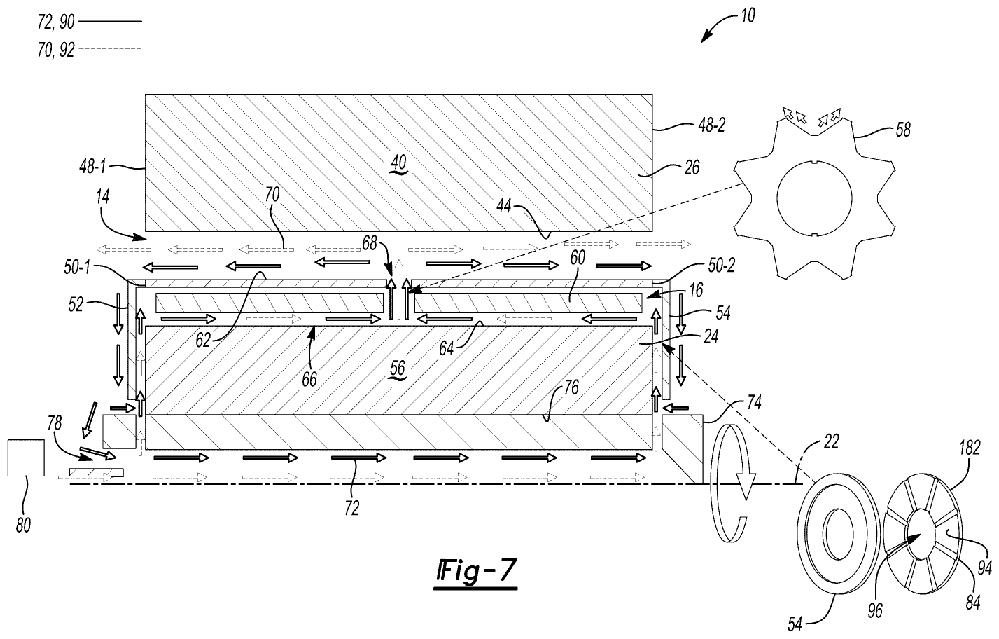

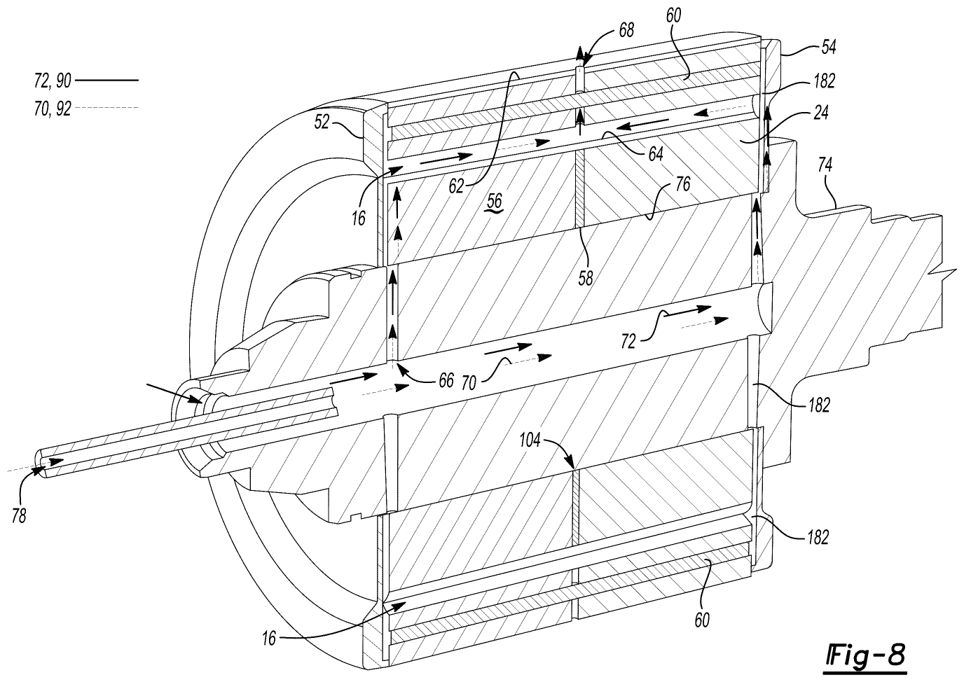

Referring now to FIGS. 7 and 8, in another embodiment, the rotor 24 may further include the pair of end rings 52, 54 each configured as an impeller 182. For this embodiment, the impeller 82 referenced above with respect to the embodiment of FIGS. 3-6 may be removed from the at least one fluid channel 68 in lieu of end rings 52, 54 configured as the impeller 182. That is, as best shown in FIG. 7, the impeller 182 may be integrated into the end rings 52, 54. In particular, the impeller 182 can be cast into the end rings 52, 54 and, as described with reference to FIG. 7, may include a guide 94, an inlet 96, and a blade 84 configured for directing the liquid 70 and the gas 72 to the plurality of magnet slots 16.

In particular, as shown in FIG. 7, the at least one fluid channel 68 may extend along each of the end rings 52, 54, through the plurality of magnet slots 16, from the radially inner rotor surface 64 to the radially outer rotor surface 62, and through the airgap 14. As such, the pair of end rings 52, 54 may pump the liquid 70 and the gas 72 from the axially opposite rotor ends 50-1, 50-2 into the plurality of magnet slots 16 to thereby directly cool the plurality of magnets 60.

That is, the liquid 70 and gas 72 may enter the rotor 24 from the sump 80 or inlet, flow through the passageway 78 of the shaft 74 to the at least one fluid channel 68, and encounter the end rings 52, 54 configured as impellers 182. Each impeller 182 may separate the liquid 70 and the gas 72 such that the gas 72 travels to the airgap 14, around the end rings 52, 54 of the rotor 24, and back to the at least one fluid channel 68. The liquid 70 may travel from the impeller 182 through the plurality of magnet slots 16, into and through the airgap 14, and out of the rotor 24 at the axially opposite rotor ends 50-1, 50-2. As such, the rotor 24 may be cooled by the liquid 70 and the gas 72 via airgap cooling and the plurality of magnets 60 may be cooled by the liquid 70 and the gas 72 via magnet slot cooling.

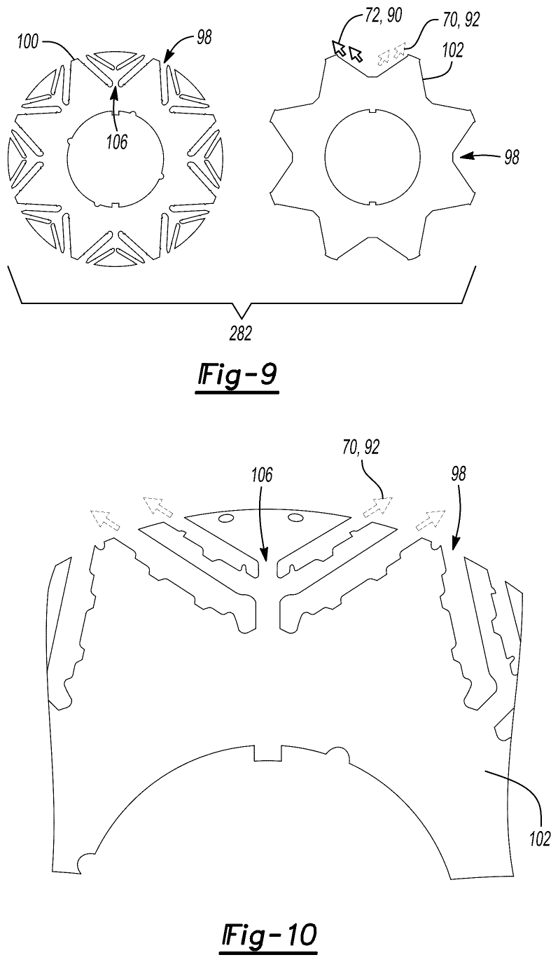

Further, referring to FIGS. 9 and 10, for this embodiment, the central ones of the plurality of laminations 58 may include openings 98 to allow the liquid 70 and the gas 72 to enter the airgap 14. More specifically, the plurality of laminations 58 may include a first central lamination 100 and a second central lamination 102 sandwiched against the first central lamination 100. The first central lamination 100 and the second central lamination 102 may together be configured for directing the liquid 70 and the gas 72 into the airgap 14.

For example, referring to FIG. 9, the first central lamination 100 may include the openings 98 to allow the fluid, i.e., the liquid 70 and the gas 72, to both pass through the first central lamination 100 and define the at least one fluid channel 68, e.g., a center channel 104 (FIG. 8) of the rotor 24, for transmitting fluid to the airgap 14. That is, the first central lamination 100 may be configured similarly to another unaltered one of the plurality of laminations 58, but may be missing bridges or portions to thereby define the openings 98 for fluid flow. Further, as compared to unaltered ones of the plurality of laminations 58, the first central lamination 100 may have thickened webs 106 to support adequate fluid flow.

Referring again to FIG. 9, the second central lamination 102 may be generally star-shaped and may also define openings 98 to direct the liquid 70 and the gas 72 into the airgap 14. Therefore, when combined with and stacked against the first central lamination 100, the second central lamination 102 may cooperate with the first central lamination 100 to function as a secondary center impeller 282 to further facilitate fluid flow into the airgap 14.

Referring to FIG. 10, in another example, a central lamination 102 may be altered as compared to a standard, unaltered one of the plurality of laminations 58 and may define the openings 98 to allow fluid flow. Further, the central lamination 102 may be sandwiched between two of the plurality of laminations 58 to thereby define the center channel 104 and transmit fluid into the airgap 14. That is, although not shown, the lamination 58 -central lamination 100 - lamination 58 may form a three-part structure to thereby create a fluid passageway and direct fluid into the airgap 14. Further, as compared to unaltered ones of the plurality of laminations 58, the central lamination 102 may have thickened webs 106 to support adequate fluid flow.

Therefore, referring again to FIG. 7, for this embodiment, the at least one fluid channel 68 may be configured to receive the liquid 70 and the gas 72 from the plurality of magnet slots 16 and direct the liquid 70 and the gas 72, via centrifugal force, into the airgap 14 to discharge the liquid 70 and the gas 72 out of the airgap 14 at the axially opposite rotor ends 50-1, 50-2 of the rotor 24 as the rotor 24 rotates inside the stator 26 to thereby cool the electric motor 10.

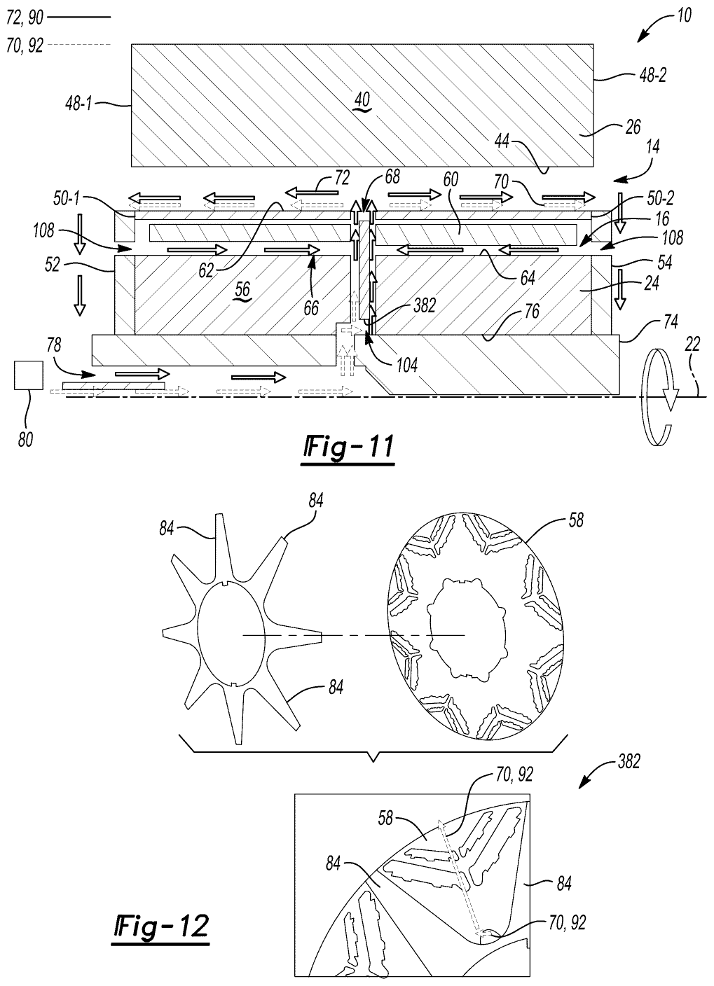

Referring now to FIG. 11, in another embodiment, the rotor 24 may further include the pair of end rings 52, 54 each disposed at a respective one of the axially opposite rotor ends 50-1, 50-2, and each of the pair of end rings 52, 54 may define a gas inlet 108. Further, the impeller 382 may be disposed in the at least one fluid channel 68, e.g., the center channel 104 of the rotor 24, and may be configured to pump the gas 72 and the liquid 70 into the airgap 14 to thereby directly cool the rotor 24.

For example, as shown in FIG. 12, the impeller 382 may be configured as a star and may include a plurality of blades 84. The impeller 382 may be disposed between and sandwiched against at least one of the plurality of laminations 58 and may operate as a pump to distribute gas 72 and liquid 70 to the airgap 14 for cooling of the electric motor 10.

That is, as best described with reference to FIG. 11, during operation of the electric motor 10, the gas 72 may circulate around each of the pair of end rings 52, 54, through the gas inlet 108 of each of the pair of end rings 52, 54, and through the plurality of magnet slots 16 via centrifugal force to thereby directly cool the plurality of magnets 60. For example, the liquid 70 and gas 72 may enter the rotor 24 from the sump 80 or inlet, flow through the passageway 78 of the shaft 74 to the at least one fluid channel 68, and encounter the impeller 382. The impeller 382 may pump the liquid 70 and the gas 72 to the airgap 14. The liquid 70 and gas 72 may travel through the airgap 14 and around the end rings 52, 54 of the rotor 24, wherein gas 72 may reenter the rotor 24 through the gas inlet 108 of each respective end ring 52, 54 for travel back to the at least one fluid channel 68 for continued circulation. As such, the rotor 24 may be cooled by the liquid 70 and the gas 72 via airgap cooling and the plurality of magnets 60 may be cooled by the gas 72 via magnet slot cooling.

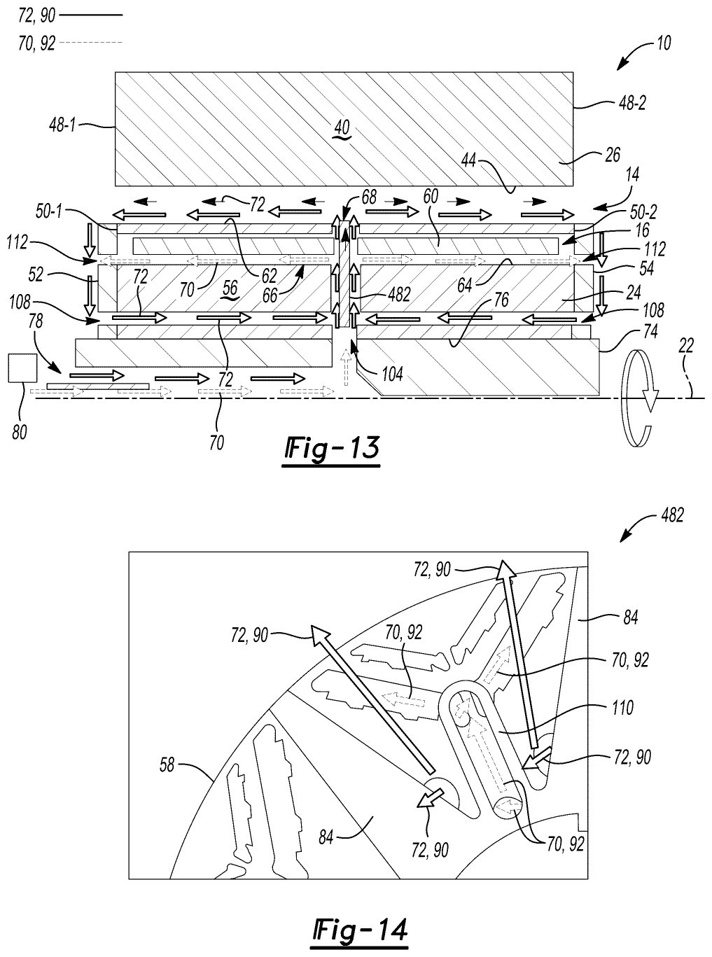

Referring now to FIG. 13, in another embodiment, the impeller 482 may be disposed in the at least one fluid channel 68, e.g., the center channel 104 of the rotor 24. As best shown in FIG. 14, the impeller 482 may include a plurality of blades 84 and a liquid bridge 110 disposed between two adjacent ones of the plurality of blades 84. The liquid bridge 110 may be configured to direct liquid 70 from the at least one fluid channel 68 to the airgap 14 to directly cool the rotor 24 and to the plurality of magnet slots 16 to thereby directly cool the plurality of magnets 60.

Further, referring again to FIG. 13, for this embodiment, each of the pair of end rings 52, 54 may further define the gas inlet 108 configured for introducing the gas 72 through the end ring 52, 54 and a liquid outlet 112 configured for directing the liquid 70 out of the plurality of magnet slots 16 through the end ring 52, 54.

Therefore, as described with continued reference to FIGS. 13 and 14, during operation of the electric motor 10, the liquid 70 and gas 72 may enter the rotor 24 from the sump 80 or inlet and flow through the passageway 78 of the shaft 74 to the at least one fluid channel 68 and encounter the impeller 482. The impeller 482 may pump the gas 72 and a portion of the liquid 70 to the airgap 14. The liquid 70 and gas 72 may travel through the airgap 14 and the liquid 70 may exit the rotor 24 at the axially opposite rotor ends 50-1, 50-2. The gas 72 may travel around the end rings 52, 54 of the rotor 24, wherein gas 72 may reenter the rotor 24 through the gas inlet 108 of each respective end ring 52, 54 for travel back to the at least one fluid channel 68 for continued circulation. The liquid 70 may also travel from the impeller 482 through the plurality of magnet slots 16 and exit each end ring 52, 54 through the respective liquid outlet 112. As such, the rotor 24 may be cooled by the liquid 70 and the gas 72 via airgap cooling and the plurality of magnets 60 may be cooled by the liquid 70 via magnet slot cooling.

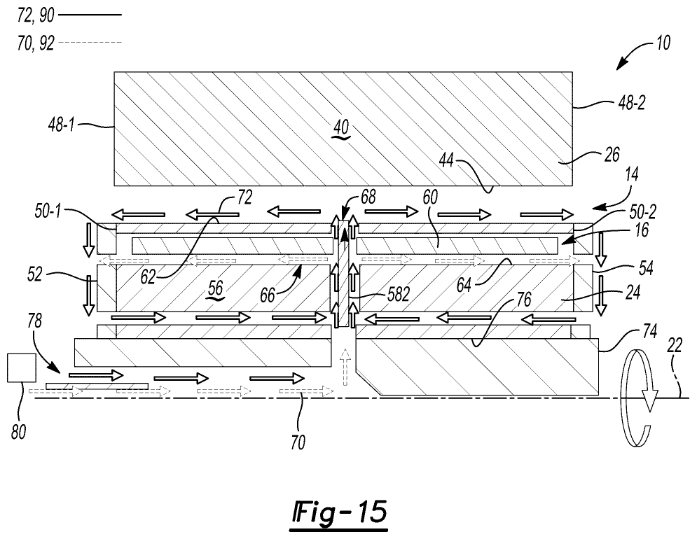

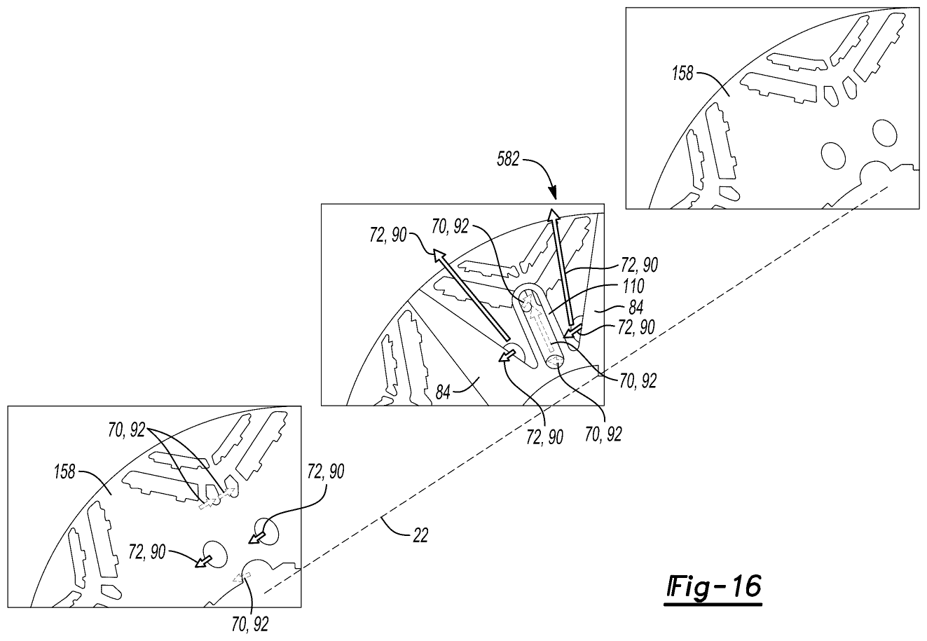

Referring to FIGS. 15 and 16, in another embodiment, the impeller 582 may have a stacked configuration. That is, the plurality of laminations 58 may include two bridge laminations 158 (FIG. 16) disposed adjacent and in contact with the impeller 582, wherein each of the two bridge laminations 158 is configured for minimizing injection of the liquid 70 from the at least one fluid channel 68 into the airgap 14.

For example, the impeller 582 may be configured as in FIG. 13 and may be disposed in the at least one fluid channel 68, e.g., the center channel 104 of the rotor 24. As best shown in FIG. 16, the impeller 582 may include the plurality of blades 84 and the liquid bridge 110 disposed between two adjacent ones of the plurality of blades 84. The liquid bridge 110 may be configured to direct liquid 70 from the at least one fluid channel 68 to the airgap 14 to directly cool the rotor 24 and to the plurality of magnet slots 16 to thereby directly cool the plurality of magnets 60. That is, the liquid bridge 110 may direct the liquid 70 to the plurality of magnet slots 16, but, in combination with the two bridge laminations 158, may not direct the liquid 70 to the airgap 14. In particular, referring to FIG. 16, the bridge laminations 158 may be stacked and sandwiched against the impeller 582 to minimize, lessen, or completely prevent the liquid 70 from entering or leaking into the airgap 14.

Therefore, as described with continued reference to FIG. 15, during operation of the electric motor 10, the liquid 70 and gas 72 may enter the rotor 24 from the sump 80 or inlet, flow through the passageway 78 of the shaft 74 to the at least one fluid channel 68, and encounter the impeller 582 stacked between the two bridge laminations 158. The impeller 582 and bridge laminations 158 may pump the gas 72 to the airgap 14. The gas 72 may travel through the airgap 14, around the end rings 52, 54 of the rotor 24, wherein gas 72 may reenter the rotor 24 through the gas inlet 108 of each respective end ring 52, 54 for travel back to the at least one fluid channel 68 for continued circulation. The liquid 70 may travel from the impeller 582 through the plurality of magnet slots 16 and exit each end ring 52, 54 through the respective liquid outlet 112. As such, the rotor 24 may be cooled by the gas 72 via airgap cooling and the plurality of magnets 60 may be cooled by the liquid 70 via magnet slot cooling.

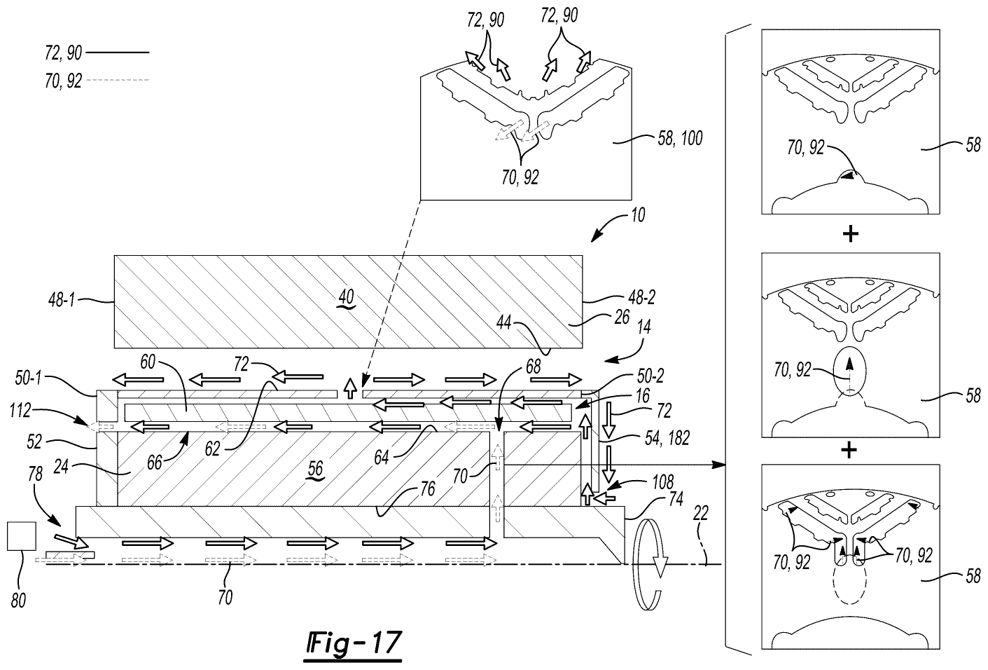

Referring to FIG. 17, in another embodiment, the rotor 24 includes one end ring 54 configured as the impeller 182 and disposed at a respective one of the axially opposite rotor ends 50-2. At the other of the axially opposite rotor ends 50-1, the end ring 52 may define the liquid outlet 112. Further, the rotor 24 may include the plurality of laminations 58 stacked adjacent one another to define the at least one fluid channel 68 extending from the shaft 74 to the radially inner rotor core surface 64. That is, by way of a non-limiting example, the plurality of laminations 58 may be shaped as shown in FIG. 17 to channel and direct the liquid 70 from the at least one fluid channel 68 to the plurality of magnet slots 16. Therefore, the end ring 54 including the impeller 182 may pump the gas 72 to the plurality of magnet slots 16 and to the airgap 14, and the plurality of laminations 58 may direct the liquid 70 to the plurality of magnet slots 16 without directing the liquid 70 to the airgap 14.

As described with continued reference to FIG. 17, during operation of the electric motor 10, the liquid 70 and gas 72 may enter the rotor 24 from the sump 80 or inlet and flow through the passageway 78 of the shaft 74 to the at least one fluid channel 68 defined by the plurality of laminations 58. The end ring 54 including the impeller 182 may pump the gas 72 to the plurality of magnet slots 16. The liquid 70 and gas 72 may travel through the plurality of magnet slots 16, and the gas 72 may travel through the plurality of magnet slots 16 to the airgap 14. The liquid 70 and gas 72 may exit the rotor 24 at the liquid outlet 112. The gas 72 in the airgap 14 may travel around the end rings 52, 54 of the rotor 24, and gas 72 may reenter the rotor 24 through the gas inlet 108 of the end ring 54 configured as the impeller 182 for continued circulation. As such, the rotor 24 may be cooled by the gas 72 via airgap cooling and the plurality of magnets 60 may be cooled by the liquid 70 and the gas 72 via magnet slot cooling.

Referring to the electric motor 10 described with reference to FIGS. 2-10 and 13-17, in some embodiments, the rotor 24 includes the fluid circulation arrangement 66 having the at least one fluid channel 68 extending within the rotor 24 to the radially outer rotor surface 62 and configured to receive oil and air; direct the oil, via centrifugal force, into the plurality of magnet slots 16; direct the air, via centrifugal force, into the airgap 14; and discharge the oil out of the plurality of magnet slots 16 and the air of the airgap 14 at the axially opposite rotor ends 50-1, 50-2 as the rotor 24 rotates inside the stator 26 to thereby cool the electric motor 10.

In summary, in each embodiment described herein, gas 72 may flow within the airgap 14 (see, e.g., FIGS. 3, 7, 11, 13, and 17), but may also flow within the plurality of magnet slots 16 (see, e.g., FIGS. 7, 11, and 17). Further, liquid 70 may flow within the plurality of magnet slots 16 (see, e.g., FIGS. 3, 7, 15, and 17), but may also flow within the airgap 14 (see, e.g., FIGS. 7, 11, and 13). In addition, liquid 70 and/or gas 72 may flow within the rotor 24 by way of an impeller 82, 182, 282, 382, 482, 582 (see, e.g., FIGS. 3, 7, 11, and 17) or without the use of an impeller 82 (see, e.g., FIGS. 13 and 15).

Therefore, in summary, the electric motor 10 and vehicle 12 may have excellent operating efficiency. That is, coolant, e.g., the liquid 70 and/or the gas 72, may be directly injected or pumped into the airgap 14 and/or the plurality of magnet slots 16 to dissipate thermal energy produced by the electric motor 10 during operation. Further, the electric motor 10 set forth herein may minimize lost efficiency, i.e., spin losses, during rotation about the rotational axis 22 that may be otherwise caused by undesired liquid leakage. In addition, the electric motor 10 may have a reduced mass and complexity and may be manufactured with improved efficiencies. For example, as set forth above, the impeller 282 may be cast directly into the end ring 52, 54 thereby reducing manufacturing costs of the electric motor 10. As such, the electric motor 10 may improve fuel economy for the vehicle 12.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. An electric motor comprising:
a stator having a radially inner stator core surface; and
a rotor mounted inside the stator and rotatable about a rotational axis, wherein the rotor has:
axially opposite rotor ends;
a radially outer rotor surface extending between the axially opposite rotor ends and positioned proximate the radially inner stator core surface to define an airgap therebetween; and
a radially inner rotor surface spaced apart from the radially outer rotor surface to define a plurality of magnet slots therebetween each configured to house a respective one of a plurality of magnets therein;
wherein the rotor includes a fluid circulation arrangement having at least one fluid channel extending within the rotor to the radially outer rotor surface and configured to receive a liquid and a gas, direct at least one of the liquid and the gas, via centrifugal force, into the plurality of magnet slots, direct at least another one of the liquid and the gas, via centrifugal force, into the airgap, and discharge the liquid and the gas out of the plurality of magnet slots and the airgap at the axially opposite rotor ends as the rotor rotates inside the stator to thereby cool the electric motor.

2. The electric motor of claim 1,
further including a shaft disposed along the rotational axis;
wherein the rotor has a radially internal rotor core surface disposed in contact with the shaft and spaced apart from the radially outer rotor surface; and
wherein the at least one fluid channel extends through the rotor from the radially internal rotor core surface to the radially outer rotor surface.

3. The electric motor of claim 2, further including an impeller disposed within the at least one fluid channel and rotatable about the rotational axis.

4. The electric motor of claim 3, wherein the impeller is configured to separate the liquid and the gas, pump the gas into the airgap to thereby directly cool the rotor, and inject the liquid into the plurality of magnet slots to thereby directly cool the plurality of magnets.

5. The electric motor of claim 3, wherein the impeller includes a blade sandwiched between a first cover and a second cover.

6. The electric motor of claim 5,
wherein the rotor is formed from a plurality of laminations stacked against one another; and
further wherein the impeller is sandwiched between two adjacent ones of the plurality of laminations to thereby define an air path from the radially internal rotor core surface to the airgap and a liquid path from the radially internal rotor core surface to the plurality of magnet slots.

7. The electric motor of claim 2,
wherein the rotor further includes a pair of end rings each configured as an impeller and disposed at a respective one of the axially opposite rotor ends;
wherein the at least one fluid channel extends along each of the end rings, through the plurality of magnet slots, from the radially inner rotor surface to the radially outer rotor surface, and through the airgap; and
wherein the pair of end rings pump the liquid and the gas from the axially opposite rotor ends into the plurality of magnet slots to thereby directly cool the plurality of magnets.

8. The electric motor of claim 7,
wherein the rotor is formed from a plurality of laminations stacked against one another;
wherein the plurality of laminations include a first central lamination and a second central lamination sandwiched against the first central lamination; and
wherein the first central lamination and the second central lamination are together configured for directing the liquid and the gas into the airgap.

9. The electric motor of claim 8, wherein the at least one fluid channel is configured to receive the liquid and the gas from the plurality of magnet slots and direct the liquid and the gas, via centrifugal force, into the airgap to discharge the liquid and the gas out of the airgap at the axially opposite rotor ends as the rotor rotates inside the stator to thereby cool the electric motor.

10. The electric motor of claim 3, wherein the impeller is configured to pump the gas and the liquid into the airgap to thereby directly cool the rotor.

11. The electric motor of claim 10, wherein the rotor further includes a pair of end rings each defining a gas inlet and disposed at a respective one of the axially opposite rotor ends.

12. The electric motor of claim 11, wherein the gas circulates around each of the pair of end rings, through the gas inlet of each of the pair of end rings, and through the plurality of magnet slots via centrifugal force to thereby directly cool the plurality of magnets.

13. The electric motor of claim 3,
wherein the impeller includes a plurality of blades and a liquid bridge disposed between two adjacent ones of the plurality of blades; and
wherein the liquid bridge is configured to direct liquid from the at least one fluid channel to the airgap to directly cool the rotor and to the plurality of magnet slots to thereby directly cool the plurality of magnets.

14. The electric motor of claim 13, wherein the rotor further includes a pair of end rings each disposed at a respective one of the axially opposite rotor ends; and
wherein each of the pair of end rings further defines a liquid outlet configured for directing the liquid out of the plurality of magnet slots.

15. The electric motor of claim 3,
wherein the rotor is formed from a plurality of laminations stacked against one another; and
wherein the plurality of laminations includes two bridge laminations disposed adjacent and in contact with the impeller and each configured for minimizing injection of the liquid from the at least one fluid channel into the airgap.

16. The electric motor of claim 1, wherein the rotor further includes an end ring configured as an impeller and disposed at a respective one of the axially opposite rotor ends.

17. The electric motor of claim 16,
wherein the rotor further includes a shaft;
wherein the rotor has a radially internal rotor core surface disposed in contact with the shaft and spaced apart from the radially outer rotor surface; and
wherein the rotor includes a plurality of laminations stacked adjacent one another to define the at least one fluid channel extending from the shaft to the radially internal rotor core surface.

18. The electric motor of claim 17, wherein the end ring pumps the gas to the plurality of magnet slots and to the airgap, and the plurality of laminations directs the liquid to the plurality of magnet slots without directing the liquid to the airgap.

19. An electric motor comprising:
a stator having a radially inner stator core surface; and
a rotor mounted inside the stator and rotatable about a rotational axis, wherein the rotor has:
axially opposite rotor ends;
a radially outer rotor surface extending between the axially opposite rotor ends and positioned proximate the radially inner stator core surface to define an airgap therebetween; and
a radially inner rotor surface spaced apart from the radially outer rotor surface to define a plurality of magnet slots therebetween each configured to house a respective one of a plurality of magnets therein;
wherein the rotor is formed from a plurality of laminations stacked against one another;
wherein the rotor includes a fluid circulation arrangement having at least one fluid channel extending within the rotor to the radially outer rotor surface and configured to receive oil and air, direct the oil, via centrifugal force, into the plurality of magnet slots, direct the air, via centrifugal force, into the airgap, and discharge the oil out of the plurality of magnet slots and the air out of the airgap at the axially opposite rotor ends as the rotor rotates inside the stator to thereby cool the electric motor.

20. A vehicle comprising:
an electric motor configured to generate torque for propulsion of the vehicle, the electric motor including:
a stator having a radially inner stator core surface; and
a rotor mounted inside the stator and rotatable about a rotational axis, wherein the rotor has:
axially opposite rotor ends;
a radially outer rotor surface extending between the axially opposite rotor ends and positioned proximate the radially inner stator core surface to define an airgap therebetween; and
a radially inner rotor surface spaced apart from the radially outer rotor surface to define a plurality of magnet slots therebetween each configured to house a respective one of a plurality of magnets therein;
wherein the rotor includes a fluid circulation arrangement having at least one fluid channel extending within the rotor to the radially outer rotor surface and configured to receive a liquid and a gas, direct at least one of the liquid and the gas, via centrifugal force, into the plurality of magnet slots, direct at least another one of the liquid and the gas, via centrifugal force, into the airgap, and discharge the liquid and the gas out of the plurality of magnet slots and the airgap at the axially opposite rotor ends as the rotor rotates inside the stator to thereby cool the electric motor.
